(19) United States
(12) Patent Application Publication
(10) Pub. No.: US 2013/0234380 A1
(43) Pub. Date: Sep. 12, 2013

(54) SPRING OF SUSPENSION FOR VEHICLE

(71) Applicants: HYUNDAI MOTOR COMPANY, Seoul (KR); KIA MOTORS CORP., Seoul (KR)

(72) Inventors: Woo Min Kyoung, Yongin-si (KR); Hyun Min Kang, Hwaseong-si (KR); Do Suck Han, Seongnam-si (KR)

(73) Assignees: Kia Motors Corp., Seoul (KR); Hyundai Motor Company, Seoul (KR)

(21) Appl. No.: 13/663,973

(22) Filed: Oct. 30, 2012

(30) Foreign Application Priority Data
Mar. 6, 2012 (KR) 10-2012-0022597

(51) Int. Cl. B60G 11/00

(52) U.S. Cl. 267/292

(57) ABSTRACT

A spring member of a suspension for a vehicle may include a spring provided to be supported between a lower seat disposed in the suspension and a car body to provide an elastic force, wherein an inner part of the spring is formed in a shape of a hollow corrugated tube.

### CROSS-REFERENCE TO RELATED APPLICATION

The present application claims priority to Korean Patent Application No. 10-2012-0022597 filed on Mar. 6, 2012, the entire contents of which is incorporated herein for all purposes by this reference.

### BACKGROUND OF THE INVENTION

1. Field of the Invention

The present disclosure relates to a spring of a suspension for a vehicle which makes it possible to replace a metal spring of a suspension by a corrugated tube-shaped spring made of a complex material.

2. Description of Related Art

In general, the car body of a vehicle is supported by a suspension connected with the tires and the suspension improves riding comfort by absorbing various vibrations and shocks generated while the vehicle travels, and adjusts the overall balance of the car body in accordance with the state of the road surface.

Further, the suspension prevents the vehicle from inclining in one direction due to a centrifugal force by keeping drivability stable for the driver against the centrifugal force, when the vehicle turns.

Meanwhile, the spring disposed in the suspension is a main part that has great influence on the mechanical behavior of the suspension by providing a reaction force against vertical motion. A leaf spring formed by stacking spring metals and a coil spring wound in a coil shape are generally used as the spring of the suspension.

As shown in FIG. 1, in a suspension 1 equipped with a coil spring 10, an insulator 12 is provided on the upper end of the coil spring 10 to be combined with a car body and the lower end of the coil spring 10 is seated on a lower seat fixed to a strut to be supported by a portion of the strut.

The coil spring 10 is usually made of metal and exposed to the outside due to the structural characteristic when being mounted in a vehicle, such that the coil spring 10 is commonly coated with paint to prevent corrosion.

As shown in FIG. 2, however, when the paint fall off due to various environments where the vehicle travels and the metal is exposed, a problem is generated in durability due to corrosion.

Further, when spring steel, which is high tension steel, is used to reduce the weight of a suspension system, brittleness of the spring is increased by addition of a silicon-based material, such that the spring may very rapidly break.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a spring of a suspension for a vehicle which makes it possible to reduce weight and vibrations by replacing a spring of a suspension by a corrugated spring made of a complex material and to providing a spring of a suspension for a vehicle which improves rigidity and non-linearity by forming a slit on the edge of the spring.

In an aspect of the present invention, a spring member of a suspension for a vehicle may include a spring provided to be supported between a lower seat disposed in the suspension and a car body to provide an elastic force, wherein an inner part of the spring is formed in a shape of a hollow corrugated tube.

The spring is made up of a compound of different materials.

The spring is composed of an inner layer and an outer layer, and the inner layer and the outer layer are made of different materials, respectively.

Elasticity of the inner layer is higher than elasticity of the outer layer.

At least a slit is formed on the outer side of the spring to control non-linear characteristics of the spring.

The at least a slit is formed perpendicular to a longitudinal axis of the spring.

The at least a slit is formed at a tip of ridge of the spring.

The at least a slit is formed in a radial direction with respect to the longitudinal axis.

The at least a slit is formed at every ridge of the spring, in a same line along the longitudinal axis.

The at least a slit is formed symmetric in a circumferential direction with respect to a longitudinal axis of the spring.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a perspective view showing the configuration for mounting a coil spring of a suspension in the related art.

FIG. 2 is a view showing coat separation and fracture of the coil spring of the related art.

FIG. 3 is a front view showing the shape of a corrugated spring according to an exemplary embodiment of the present invention.

FIG. 4 is an enlarged cross-sectional view showing the structure of the inner layer and the outer layer by cutting the spring according to an exemplary embodiment of the present invention.

FIG. 5 is a perspective view and a plan view showing the arrangement of slits formed on the spring according to an exemplary embodiment of the present invention.

FIG. 6 is a diagram comparing the degrees of attenuating vibrations in the spring made of a complex material according to an exemplary embodiment of the present invention and a metal spring of the related art.

FIG. 7 is a diagram comparing the natural frequencies and the corresponding shapes in the spring made of a complex material according to an exemplary embodiment of the present invention and a metal spring of the related art.

FIG. 8 is a diagram comparing characteristics according to changes in corrugation angle, outer diameter of grooves and outer diameter of ridges in the spring according to an exemplary embodiment of the present invention.

FIG. 9 is a diagram comparing non-linear characteristics according to existence of slits and the number of slits in the spring according to an exemplary embodiment of the present invention.

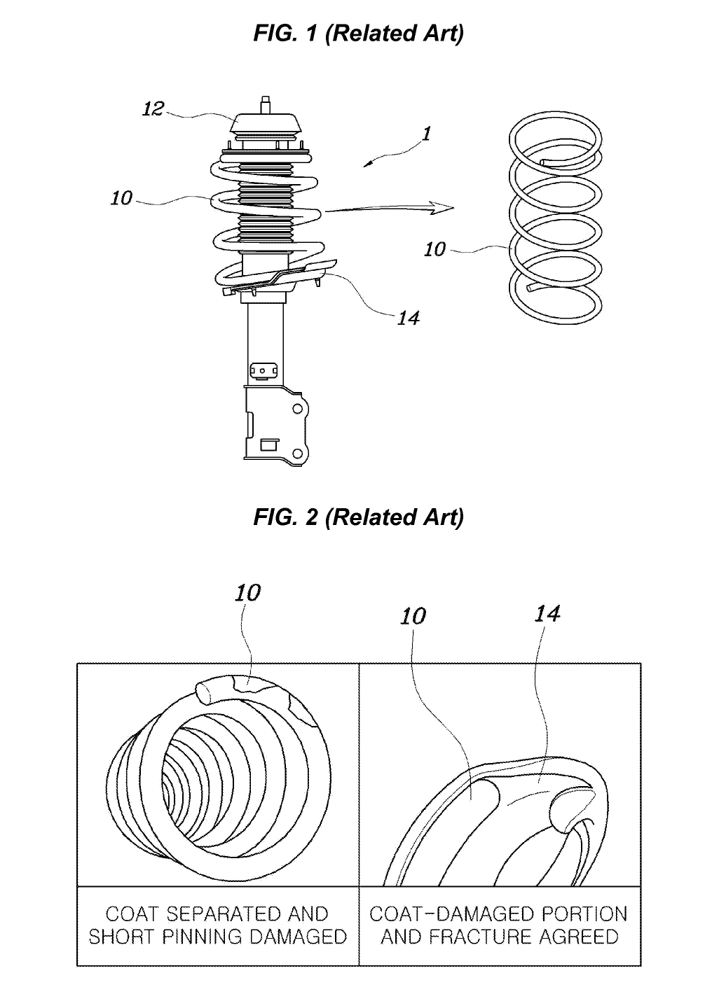

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter reference will now be made in detail to various embodiments of the present invention, examples of which are illustrated in the accompanying drawings and described below.

Preferred embodiments of the present invention are described hereafter in detail with the accompanying drawings.

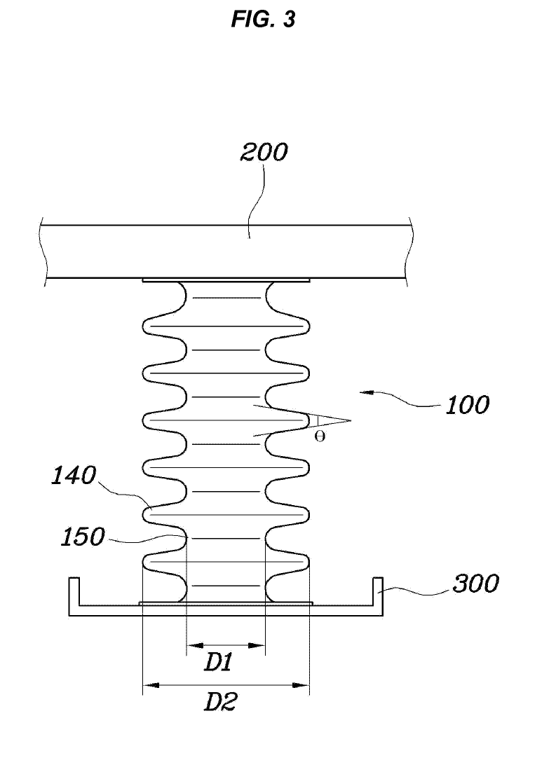

FIG. 3 is a front view showing the shape of a corrugated spring 100 according to an exemplary embodiment of the present invention.

As shown in the figure, the spring 100 according to an exemplary embodiment of the present invention is formed in the shape of a hollow corrugated tube and supported between a lower seat 300 disposed in a suspension and a car body 200 to provide an elastic force.

In detail, the spring 100 may be disposed, with the upper end supported by the car body 200 through an insulator and the lower end of the spring 100 seated and supported on the lower seat 300 disposed on a strut of a suspension.

That is, the corrugated spring 100 is disposed in a suspension, replacing the coil springs of the related art. The structure of the corrugated spring 100 provides a function of generating a repulsive reaction force due to elastic deformation at the ends of the corrugated structure against vertical load and returning to the original shape when the load is removed.

Further, when large load at a predetermined level or more is applied, the upper and lower surfaces come in contact with each other in the corrugated structure and a large repulsive reaction force is kept, such that the spring 100 performs the same operation as the metal springs of the related art.

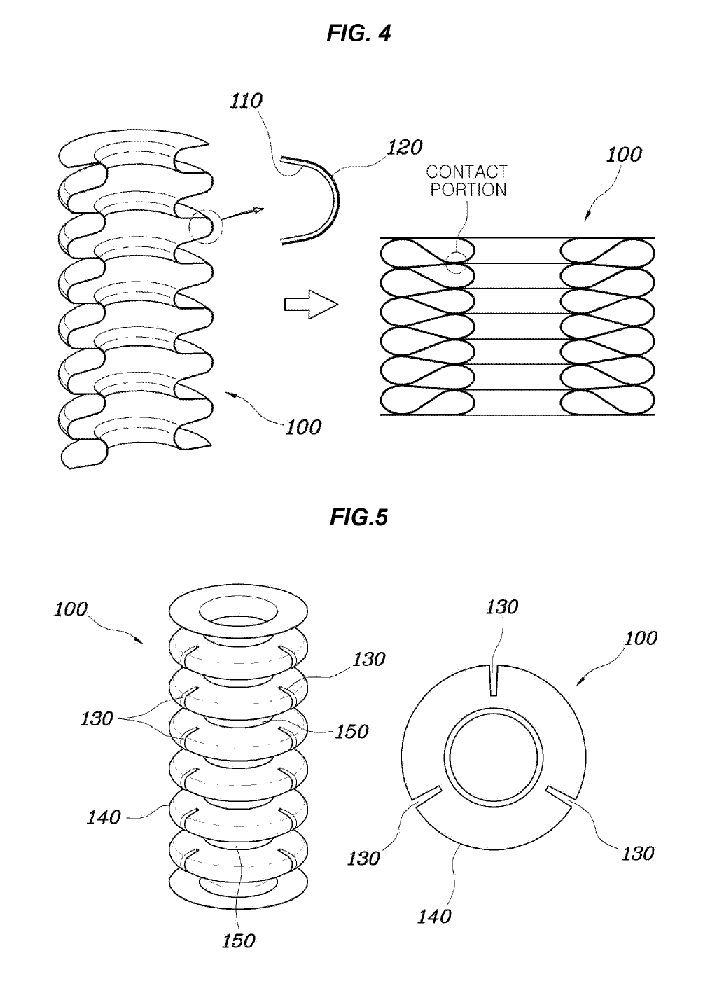

FIG. 4 is an enlarged cross-sectional view showing the structure of the inner layer 110 and the outer layer 120 by cutting the spring 100 according to an exemplary embodiment of the present invention

As shown in the figure, the spring 100 according to an exemplary embodiment of the present invention may be manufactured with a compound of different materials. In detail, the spring 100 includes the inner layer 110 and the outer layer 120, and the inner layer 110 and the outer layer 120 may be made of different materials. Preferably, the inner layer 110 may be made of an elastic material and the outer layer 120 may be made of a high-rigidity material. The high-rigidity material may be an alloy of different materials, or single metal.

That is, according to an exemplary embodiment of the present invention, a shock is reduced when the inner diameter comes in contact with the spring 100 by compression and NVH performance of the suspension is improved by high vibration attenuation force, by manufacturing the spring 100 from two materials of the inner layer 110 and the outer layer 120, using an elastic material for reducing a vibration for the inner layer 110.

Further, the spring 100 is provided with rigidity by forming the outer layer 120 of a high-rigidity complex material.

FIG. 5 is a perspective view and a plan view showing the arrangement of slits 130 formed on the spring 100 according to an exemplary embodiment of the present invention.

As shown in the figure, it is possible to control non-linear characteristics of the spring 100 by forming groove-shaped slits 130 on the outer side of the spring 100.

In detail, the slits 130 may be formed perpendicular to the axis of the spring 100. That is, the slits 130 are formed perpendicular to the central axis extending in the longitudinal direction of the spring 100, in which the slits 130 may be radially formed on the corrugated spring 100.

In this configuration, one or more slits 130 may be formed and the non-linearity characteristics depends on the number of the slits 130, such that it is possible to adjust the number of the slits 130 in order to control non-linearity to satisfy the user's demands.

Further, the slits 130 may be formed at the tips of the ridges 140 of the spring 100. Further, the slits 130 may be formed at every ridge 140 of the spring 100, in the same lines with respect to the axis.

That is, the corrugated spring 100 has a structure with the ridges 140 and the grooves 150 that are alternately formed, and the slits 130 may be formed at the tips of the ridges 140 of the spring 100. Further, the slits 130 may be formed in the same vertical line, at the ridges 140 of the spring 100, but the present invention is not limited thereto.

In an exemplary embodiment of the present invention, the slits 130 are formed symmetric in a circumferential direction with respect to the longitudinal axis of the spring 100.

The operation and effect of the present invention are described in detail.

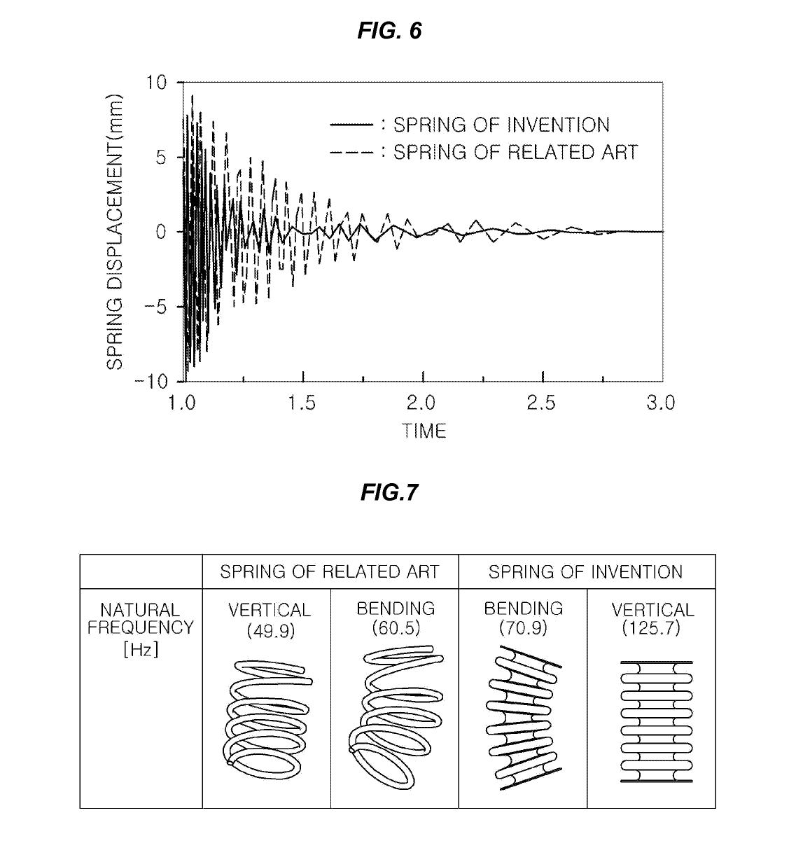

FIG. 6 is a diagram comparing the degrees of attenuating vibrations in the spring 100 made of a complex material according to an exemplary embodiment of the present invention and a metal spring of the related art. Since a complex material generally has a damping coefficient higher than a single metal material, when the same vibration is generated, the complex material attenuates the vibration faster. That is, the spring 100 made of a complex material according to an exemplary embodiment of the present invention reduces vibration of a suspension faster than a coil spring made of metal, such that riding comfort can be improved and the vibrations of a wheel transmitted through the spring 100 is attenuated faster and transmitted to the vehicle.

FIG. 7 is a diagram comparing the natural frequencies and the corresponding shapes in the spring 100 made of a complex material according to an exemplary embodiment of the present invention and a metal spring of the related art.

That is, in the structure of the spring 100 having the same rigidity, the weight of the spring 100 made of a complex material according to an exemplary embodiment of the present invention is considerably smaller than the weight of a coil spring made of metal, such that the natural frequency of the spring 100 is higher than the metal spring (49.9 Hz→70.9 Hz). Therefore, since the possibility that the high natural frequency resonates with a low frequency band (50 Hz or less) inputted from a load while a vehicle travels is significantly low, the NVH-related performance is very excellent.

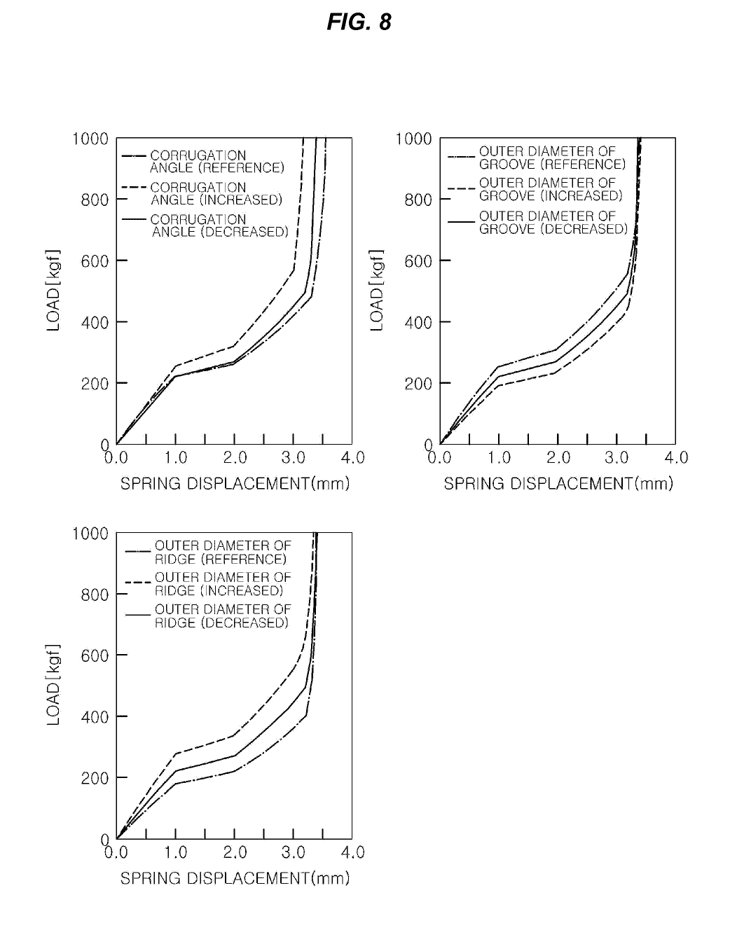

FIG. 8 is a diagram comparing characteristics according to changes in corrugation angle θ, outer diameter D1 of grooves 150 and outer diameter D2 of ridges 140 in the spring 100 according to an exemplary embodiment of the present invention wherein the corrugation angle θ, the outer diameter D1 of the grooves 150 and the outer diameter D2 of the ridges 140, or the thicknesses of the inner layer 110 and the outer layer 120 change, the displacement characteristic of the spring 100 to the load changes, as shown in FIG. 8. Therefore, it is possible to design characteristics of the spring 100 which fit to the user's demands by changing the design variables of the spring 100.

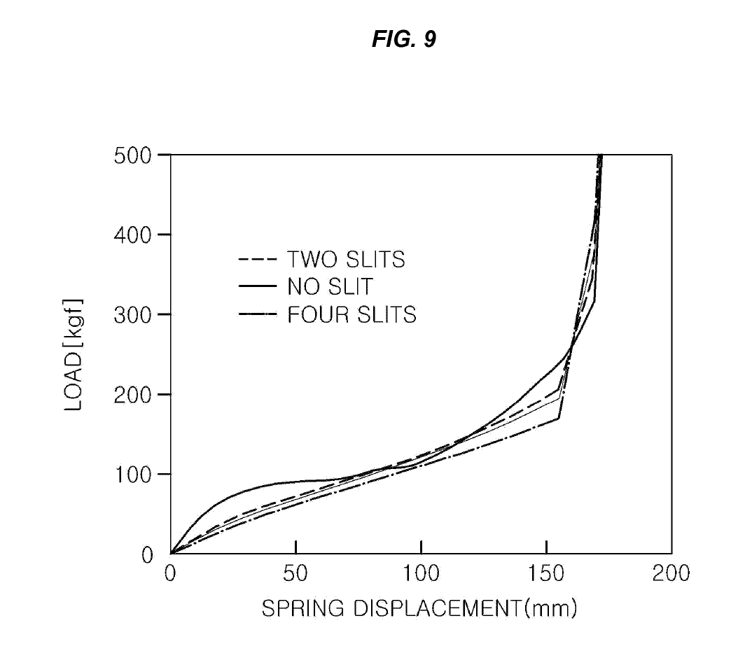

FIG. 9 is a diagram comparing non-linear characteristics according to existence of slits and the number of slits 130 in the spring 100 according to an exemplary embodiment of the present invention, in which the non-linear characteristics of the spring 100 change, as shown in the figure. Therefore, it is possible to design the spring to control the non-linear characteristic of the spring to satisfy the user's demands, using those shown in the figure.

According to an exemplary embodiment of the present invention, since the inner layer and the outer layer of the spring are made of different materials, respectively, the damping coefficient of the spring made of a complex material is higher than that of a metal spring and vibrations of a suspension are reduced faster, such that it is possible to improve riding comfort and to attenuate faster the vibration transmitted through the spring from a wheel.

Further, the weight of a spring made of a complex material is considerably smaller than the weight of a coil spring made of metal so that the natural frequency of the spring is higher than the metal spring. Therefore, the possibility that the high natural frequency resonates with a low frequency band (50 Hz or less) inputted from a load while a vehicle travels is significantly low so that the NVH-related performance is very excellent.

Further, it is possible to freely adjust rigidity and non-linearity of the spring by forming slits on the spring or changing the cross-sectional structure including the outer diameter of the spring or the corrugation angle so that it is possible to improve stability in driving of a vehicle by designing a spring to satisfy the characteristics of the spring that are required by a suspension.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A spring member of a suspension for a vehicle, comprising:
a spring provided to be supported between a lower seat disposed in the suspension
and a car body to provide an elastic force, wherein an inner part of the spring is formed in a shape of a hollow corrugated tube.

2. The spring member according to claim 1, wherein the spring is made up of a compound of different materials.

3. The spring member according to claim 1, wherein the spring is composed of an inner layer and an outer layer, and the inner layer and the outer layer are made of different materials, respectively.

4. The spring member according to claim 3, wherein elasticity of the inner layer is higher than elasticity of the outer layer.

5. The spring member according to claim 1, wherein at least a slit is formed on the outer side of the spring to control non-linear characteristics of the spring.

6. The spring member according to claim 5, wherein the at least a slit is formed perpendicular to a longitudinal axis of the spring.

7. The spring member according to claim 5, wherein the at least a slit is formed at a tip of ridge of the spring.

8. The spring member according to claim 5, wherein the at least a slit is formed in a radial direction with respect to the longitudinal axis.

9. The spring member according to claim 5, wherein the at least a slit is formed at every ridge of the spring, in a same line along the longitudinal axis.

10. The spring member according to claim 5, wherein the at least a slit is formed symmetric in a circumferential direction with respect to a longitudinal axis of the spring.
